(19) United States
(12) Patent Application Publication
(10) Pub. No.: US 2010/0282002 A1
(43) Pub. Date: Nov. 11, 2010

(54) MEASURING DEVICE FOR DETECTING THE OPERATING STATE OF A SHAFT, METHOD AND SHAFT ARRANGEMENT COMPRISING SAID MEASURING DEVICE

(75) Inventors: Tobias Hagemann, Aachen (DE); Christian Schaaf, Aachen (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/738,410

(22) PCT Filed: Oct. 16, 2008
(86) PCT No.: PCT/DE08/01693

§ 371 Date: Jul. 19, 2010

(30) Foreign Application Priority Data
Oct. 17, 2007 (DE) 10 2007 049 672.0

(51) Int. Cl. G01L 3/10

(52) U.S. Cl. 73/862.326

(57) ABSTRACT

A measuring device, a method, and a shaft arrangement. The device enables and detects a robust and simultaneously precise measurement of torque, a torque variation and/or an equivalent variable. The device has a signal emitter that can be and/or is connected to the shaft in a rotationally fixed manner, a signal receiver to detect signals from the signal emitter and emit a measuring signal which has a constituent dependent on rotational speed, according to the detection of the signals of the signal emitter. The measuring device also has an evaluation device for determining the torque operating state of the shaft on the basis of, and/or, by evaluation of the measuring signal. The evaluation device carries out and/or completes the determination of the torque operating state by analyzing signal constituents of the measuring signal that have a limiting frequency which is higher than the current rotational frequency of the shaft.

### FIELD OF THE INVENTION

The invention relates to a measurement apparatus for detection of the torque operating state of a shaft in the form of a torque, a torque change and/or a variable equivalent thereto having a signal transmitter which is connectable and/or is connected to the shaft such that they rotate together, having a signal receiver, which is designed for detection of the signal transmitter and outputs a measurement signal, with a rotation-speed-dependent component, as a function of the detection of the signal transmitter, and having an evaluation apparatus for determination of the torque operating state of the shaft on the basis of and/or by evaluation of the measurement signal. The invention furthermore relates to a corresponding method for detection of a torque operating state of a shaft, and to a shaft arrangement having the measurement apparatus.

The measurement of a torque or a torque change of a shaft during operation is often part of the monitoring of a manufacturing machine or process machine. The torque must be known in order, for example, to make it possible to make estimates relating to the work quality, load or wear of the respective machines.

The determination of the torque by measurement is often carried out by means of a intermediate element coupled in series, whose torsion is measured and is converted into a torque using predetermined characteristics. For example, optical measurement methods are used in which the pivoting of two reference marks, which are separated by an axial distance from one another, are detected in the circumferential direction by measurement. Other measurement systems evaluate the torsion of the intermediate element by mechanical or magnetic measurement means. However, the intermediate elements which are required for the measurement methods restrict the applicability of measurement methods of this type to shafts which transmit only low torques.

In another type of torque measurement, the torsion of the torque-loaded shaft is measured directly using various measurement methods. By way of example, in these measurement methods, the shaft is provided with strain gauges which detect the torsion. Methods are also known in which the change in the magnetic field resulting from the torsion of the shaft is measured, and a torque is derived from this. These methods evaluate position differences resulting from torsion in a sub-millimeter range and therefore, by virtue of the system, are susceptible to disturbances in severe operating environments, for example in the case of contamination, the influence of heat and the like.

It is normal practice to make use of the electric current of the drive motor of the shaft as a calculation basis for estimation of a torque which is actually transmitted via the shaft. In this case, the motor current or the motor power is calculated using a shaft rotation speed taken at any desired position, and a torque is estimated from this. In the article “Messen direkt an der Welle” [Measurement directly on the shaft] by Lutz May, which was published in “Computer & Automation” 8/05, page 73 et seq, the last-mentioned solution was considered to be disadvantageous since this solution was said to produce excessively slow reaction times, inaccurate measurements and a constantly changing reference base. As a solution, the article proposes that, rather than determining the torque via the motor current, a magnetic coding be applied to the shaft, and that the torque be determined via the magnetic field, which varies as a function of the load or torsion, independently of the rotation speed or rotation direction of the shaft.

The invention is based on the object of proposing a measurement apparatus, a method and a shaft arrangement having the measurement apparatus, which allow robust and at the same time exact detection of the torque, a torque change and/or a variable equivalent thereto.

This object is achieved by a measurement apparatus having the features of claim 1, by a method having the features of claim 11, and by a shaft arrangement having the features of claim 13. Preferred or advantageous embodiments of the invention are specified in the dependent claims, in the following description and in the attached figures.

According to the invention, a measurement apparatus is proposed for detection of a torque operating state of a shaft, wherein the torque operating state describes the torque transmitted via the shaft, its change and/or a variable equivalent thereto.

The measurement apparatus includes a signal transmitter which is connectable and/or is connected to the shaft such that they rotate together, wherein the signal transmitter rotates with the shaft during operation of the latter. On the one hand, the signal transmitter may represent a separate component, which is attached to or mounted on the shaft in any desired manner. As an alternative to this, the signal transmitter is in the form of a component which is connected integrally and/or as one piece to the shaft. The signal transmitter may, in the most general definition, be designed to output and/or change any desired signal, in particular a magnetic, optical, electrical, electromagnetic, capacitive and/or inductive signal.

The measurement apparatus furthermore has a signal receiver which is designed for detection of the signal transmitter. The signal receiver may be in the form of a passive signal receiver, in which case a signal which is emitted actively by the signal transmitter is detected, or may be in the form of an active signal receiver, in which case the signal receiver transmits a test signal to the signal transmitter, which modifies the test signal, and the signal receiver then receives the modified test signal.

The signal receiver is designed by programming and/or circuitry such that a measurement signal with a component which is dependent on the rotation speed of the shaft is output, as a function of the detection of the signal transmitter.

Furthermore, the measurement apparatus has an evaluation apparatus which determines the torque operating state of the shaft on the basis of or by evaluation of the measurement signal.

The invention proposes that the evaluation alignment be designed by programming and/or circuitry such that the torque operating state is determined and/or the determination of the torque operating state is added to by analysis of signal components of the measurement signal with a cut-off frequency that is greater than the current revolution frequency.

Therefore, as a distinction from the known prior art, not only is the revolution frequency of the shaft used as a variable, which changes slowly over time, to determine the torque operating state, but the high-frequency components of the measurement signal are used for high-dynamic determination of the torque operating state of the shaft. The measurement signal is preferably evaluated such that the rotation speed and at least one further characteristic variable are determined from the measurement signal, wherein the further characteristic variable is used to determine the torque operating state. In particular, the characteristic variable is in the form of a time-dependent information signal, wherein the components of the information signal which carry information are in a frequency range above the cut-off frequency.

The torque operating state is optionally determined using a high-pass-filtered measurement signal with a cut-off frequency higher than the current revolution frequency and/or the maximum revolution frequency of the shaft.

The measurement signal is preferably in the form of a position time signal and/or angle time signal, which provides time-dependent position and/or angle information relating to the shaft. Alternatively or additionally, the measurement signal may also be in the form of a speed and/or acceleration signal.

One idea of the invention is that, particularly, high-frequency torque changes can be verified by a change in the synchronization of the shaft, provided that the synchronization of the shaft is recorded with sufficient accuracy by measurement. In return, it is possible to use discrepancies in the synchronization of the shaft to deduce the current torque and/or a current torque change and/or an equivalent variable thereto. The measurement apparatus therefore has the advantage that the torque or the torque change of a shaft can be measured with high accuracy with a comparatively simple, and therefore robust, measurement configuration.

In one preferred embodiment of the invention, the cut-off frequency is a plurality of times, preferably at least ten times, in particular one hundred times, and especially one thousand times the revolution frequency and/or the maximum revolution frequency and/or the maximum revolution frequency of the shaft. These high-frequency signal components of the measurement signal carry the information about the instantaneous torque or about the instantaneous torque change.

In one preferred development of the invention, the torque operating state of the shaft is determined using a further auxiliary variable, wherein the further auxiliary variable is dependent on the current torque on the shaft. One particularly preferred alternative for the auxiliary variable is a variable which is proportional to the current and/or to the power and/or to the voltage of a motor driving the shaft and/or of a generator driven by the shaft. In the situation in which the unit driving the shaft is not an electric motor but, for example, is an internal combustion engine, a rotation speed, a consumption or the like of the engine is used, for example, in order to form the further auxiliary variable.

In one preferred design embodiment of the signal transmitter, this signal transmitter has a plurality of coding features which distributable and/or are distributed in the circumferential direction around the shaft. More than one hundred coding features are preferably applied to a shaft.

In principle, the coding features may be provided at different distance from one another, and/or in each case in a different way, in the circumferential direction. In one preferred embodiment, which makes it easier to evaluate the measurement signal, the coding features are, however, designed to be the same and/or are arranged at equal distances from one another in the circumferential direction. The coding features are particularly preferably arranged on a common radial plane at right angles to the rotation axis of the shaft, in such a way that they are also each in the same axial position.

In one particularly robust and therefore preferred embodiment of the invention, the signal transmitter or the coding features has or have a magnetic coding which is detected by the signal receiver. Especially the magnetic coding is very robust, and applicable in an error-free manner, even in a severe industrial environment—for example compared with optical coding.

In particular, the invention provides that the signal transmitter and the signal receiver are in the form of incremental encoder devices which produce at least 10, preferably at least 100, and in particular at least 1000, signals per revolution of the shaft. In this case, on the one hand, it is possible for the number of coding features to correspond to the number of signals. On the other hand, it is also possible to use a plurality of signal receivers, or a multistage signal receiver, which, arranged physically offset with respect to one another, read a coding feature at different circumferential positions on the shaft. For example, in the case of a shaft with 100 coding features and 5 distributed signal receivers, a measurement signal is produced which comprises 500 signals per revolution.

A further subject matter of the invention relates to a method for measurement of the torque of a shaft having the features of claim 11, preferably using the measurement apparatus described above.

In the measurement method, a measurement signal with a rotation-speed-dependent component of the shaft is recorded and the torque operating state is determined and/or the determination of the torque operating state is added to, by analysis of signal components of the measurement signal with a cut-off frequency that is greater than the current revolution frequency of the shaft. The torque operating state is optionally determined using an auxiliary variable, as has already been described.

A further subject matter of the invention relates to a shaft arrangement, in particular in a mill, for example for steel, in a printing mechanism, for example for paper, in a wind power installation, for example for the rotor, in a marine vessel propulsion system, for example for driving the propeller, having a drive shaft for driving a cylinder, generator, a propeller or the like, wherein the drive shaft is designed and/or arranged to transmit high powers of more than 100 kW, preferably of more than 1 MW, and in particular of more than 10 MW, wherein the torque operating state is determined using a measurement apparatus as already described, and using a corresponding measurement method.

In one preferred implementation of the shaft arrangement, the signal transmitter is arranged in or on a torque-loaded intermediate element. Particularly in the case of implementation, care should be taken to ensure that the signal transmitter is not positioned at a free, unloaded shaft end. In contrast, it is preferable for the signal transmitter to be arranged on an intermediate element in the kinematic chain between the torque generator and the torque load. In this case, for example, the torque generator is in the form of a motor and the torque load is in the form of the rollers of the mill or the printed mechanism. The signal transmitter is preferably fitted immediately in front of the torque load, in particular on its input shaft.

In alternative embodiments, the torque generator is, for example, driven by wind power or water power, or is in the form of an internal combustion engine. The torque load is in the form of a generator, marine vessel propeller, etc. In these embodiments as well, it is preferable for the signal transmitter to be positioned in the area of the torque load.

In summary, the advantages of preferred embodiments of the invention are, in particular, that by using high-precision rotation-speed measurement and by considerably increasing the signal sampling rate, torque operation states can be determined with an accuracy which, until now, has been possible to achieve only, for example, by systems based on strain gauges. The invention is therefore distinguished by the advantages of a simple sensor system, a simple application technique and a low level of expenditure. The rotation-speed transmitter is particularly preferably positioned in the area of the torque load and, in particular, is not arranged at the shaft end of the motor shaft where there is no torque. The invention makes use of the fact that damping effects determined by the measurement method, and which result from the mechanism, are determined with the aid of analytical methods, such as transfer functions, state regulators, neural networks, fuzzy logic etc., and are implemented in the calculation of the torque.

Further features, advantages and effects of the invention will become evident from the following description of one preferred exemplary embodiment of the invention. In the figures:

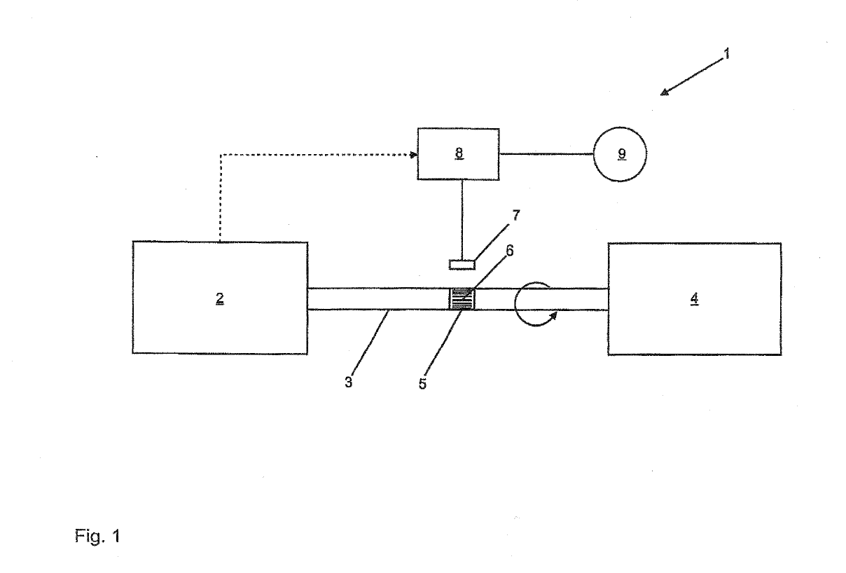

FIG. 1 shows a highly schematic block diagram of a measurement apparatus for determination of a torque operating state, as a first exemplary embodiment of the invention;

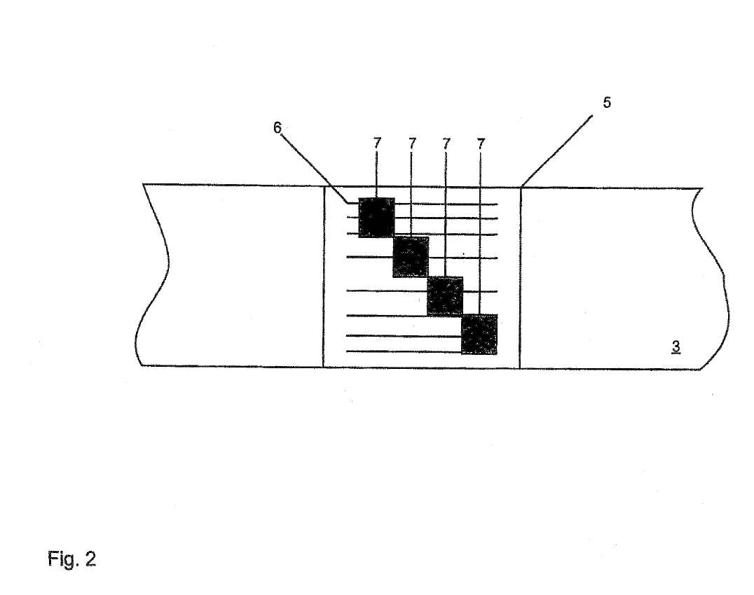

FIG. 2 shows a highly schematic illustration of the signal transmitter receiver area in FIG. 1.

FIG. 1 uses a highly schematic block diagram to show a shaft arrangement 1 which comprises a torque generator 2, for example an electric motor or internal combustion engine, at least one torque-transmitting drive shaft 3 and a torque load 4, with a torque being transmitted from the torque generator 2 via the drive shaft 3 to the torque load 4. By way of example, the torque load is in the form of a mill, printing roller a printing machine, generator or the like.

A signal transmitter 5 is arranged in the torque-loaded area on the drive shaft 3 and has a multiplicity of coding features 6 distributed in the circumferential direction. The coding features 6 are preferably in the form of magnetic codings, the number of which in this embodiment is preferably more than 2000.

A signal receiver 7, which scans the coding features 6 in a non-contacting manner, is provided in order to detect the coding features 6 of the signal transmitter 5. The signal receiver 7 uses the scanned signals to generate a measurement signal, which therefore provides a time-dependent signal.

The measurement signal is transmitted to an evaluation apparatus 8, which determines a torque and/or a torque change in the transmission of the drive shaft 3 on the basis of the high-frequency components, in particular components at frequencies higher than the revolution frequency of the drive shaft 3.

The torque generator 2 optionally transmits power signals as an auxiliary variable which, for example in the case of an electric motor, may be in the form of current signals and/or voltage signals, and in the case of an internal combustion engine may be in the form of a rotation speed or consumption.

One possible embodiment alternative is for slowly varying components of the torque to be detected by the change in the performance data of the torque generator 2, and for more rapid changes in the torque to be determined by evaluation of the high-frequency measurement signal. By way of example, rapid changes are determined by evaluating the time intervals between two successive increments, the shape or the edge gradient of the individual pulses of the increments.

FIG. 2 illustrates, highly schematically, one possible embodiment of the transmitter/receiver area for the shaft arrangement in FIG. 1. The coding features 6 are in the form of magnetic codings in the form of axially aligned strips. In order to ensure that the coding features are detected by the signal receivers without any disturbances, the strips are separated by a distance of 5 mm to 10 mm in the circumferential direction. In order to nevertheless provide a sufficiently large number of signals per revolution, a plurality of signal receivers 7 are arranged in the circumferential direction and axially offset with respect to one another, as a result of which each coding feature 6 is read more than once per revolution, in this example four times per revolution.

### LIST OF REFERENCE SYMBOLS

1 Shaft arrangement
2 Torque generator
3 Drive shaft
4 Torque load
5 Signal transmitter
6 Coding feature
7 Signal receiver
8 Evaluation apparatus

1. A measurement apparatus for detection of a torque operating state of a shaft in a form of a torque, a torque change and/or a variable equivalent thereto, comprising:
a signal transmitter, which is connectable and/or is connected to the shaft such that the shaft and the signal transmitter rotate together;
a signal receiver, which is designed for detection of the signal transmitter and outputs a measurement signal, with a rotation-speed-dependent component, as a function of the detection of the signal transmitter; and
an evaluation apparatus for determination of the torque operating state of the shaft on a basis of and/or by evaluation of the measurement signal,
wherein the evaluation apparatus is designed to determine the torque operating state and/or to add to a determination of the torque operating state by analysis of signal components of the measurement signal with a cut-off frequency that is greater than the current revolution frequency of the shaft.

2. The measurement apparatus of claim 1, wherein the cut-off frequency is a plurality of times, preferably at least 10 times, and in particular at least 100 times, and especially at least 1000 times the revolution frequency.

3. The measurement apparatus of claim 1, wherein the evaluation device is designed to determine the operating state using a further auxiliary variable, wherein the further auxiliary variable is dependent on the current torque of the shaft.

4. The measurement apparatus of claim 3, wherein the further auxiliary variable is a variable which is proportional to the current of a motor driving the shaft and/or a generator driven by the shaft.

5. The measurement apparatus of claim 1, wherein the signal transmitter has a plurality of coding features which are distributable and/or are distributed in a circumferential direction around the shaft.

6. The measurement apparatus of claim 5, wherein the coding features are designed to be the same and/or are arranged at equal distances from one another in the circumferential direction.

7. The measurement apparatus of claim 5, wherein the coding features are arranged on a common radial plane at right angles to a rotation axis of the shaft.

8. The measurement apparatus of claim 1, wherein the signal transmitter has a magnetic coding which is detected by the signal receiver.

9. The measurement apparatus of claim 1, wherein the signal transmitter and the signal receive are in the form of incremental encoder devices.

10. The measurement apparatus of claim 9, wherein the encoder device produces at least 10, preferably at least 100, and in particular at least 1000, signals per revolution.

11. A method for detection of a torque operating state of a shaft in the form of a torque, a torque change and/or a variable equivalent thereto, wherein a measurement apparatus as claimed in claim 1, records a measurement signal with a rotation-speed-dependent component of the shaft and determines the torque operating state, and/or adds to the determination of the torque operating state, by analysis of signal components of the measurement signal with a cut-off frequency that is greater than the current revolution frequency of the shaft.

12. The method of claim 11, wherein the torque operating state of the shaft is determined using the rotation-speed-dependent component and a further auxiliary variable, wherein the auxiliary variable is a torque value which is determined via a motor current of a motor driving the shaft.

13. A shaft arrangement, in particular a mill, a printing mechanism, a wind power installation, a marine vessel propulsion system etc., comprising:
a drive shaft for driving a cylinder, generator, propeller, a roller or the like,
wherein the drive shaft is designed to transmit high powers of more than 100 kW, preferably of more than 1 MW, and in particular of more than 10 MW, and
wherein a torque operating state of the drive shaft is determined by a measurement apparatus of claim 1 and/or by means of a method having the features of claim 11.

14. The shaft arrangement of claim 13, wherein the signal transmitter is arranged in or on a torque-loaded intermediate element.

15. The shaft arrangement of claim 14, wherein the signal transmitter is arranged on a or the intermediate element in the kinematic chain between the torque generator and the torque load.
